(19) United States
(12) Patent Application Publication
(10) Pub. No.: US 2021/0071365 A1
(43) Pub. Date: Mar. 11, 2021

(54) FABRIC INCLUDING REPAIRABLE POLYMERIC LAYER WITH SEAM FOR PAPERMAKING MACHINE

(71) Applicant: STRUCTURED I, LLC, Great Neck, NY (US)

(72) Inventors: James E. Sealey, II, Belton, SC (US); Byrd Tyler Miller, IV, Easley, SC (US); Zachary John Korkowski, Greenville, SC (US); Marc Paul Begin, Simpsonville, SC (US); Andrew James Carlson, Hopkins, MN (US); Mikhail Tikh, St. Louis Park, MN (US); Robert Earl Simon, Plymouth, MN (US); Nathaniel Michael Peterson, Champlin, MN (US)

(21) Appl. No.: 17/010,994

(22) Filed: Sep. 3, 2020

Related U.S. Application Data
(60) Provisional application No. 62/960,763, filed on Jan. 14, 2020.
(60) Provisional application No. 62/897,596, filed on Sep. 9, 2019.

(51) Int. Cl. D21F 7/08; D03D 1/00; D03D 15/00; B32B 5/26; B32B 5/02; B32B 7/09; B32B 7/14; B32B 27/12; B32B 27/06; B32B 27/36; B32B 37/02; B32B 3/06; D03D 11/00; D21F 7/10

(52) U.S. Cl. CPC D21F 7/083; B32B 2433/00; D03D 15/00; B32B 5/26; B32B 5/024; B32B 7/09; B32B 7/14; B32B 27/12; B32B 27/06; B32B 27/36; B32B 37/02; B32B 3/06; D03D 11/00; D21F 7/10; D03D 2700/0162; D10B 2331/10; B32B 2262/0292; B32B 2262/0284; D10B 2331/04; B32B 2274/00; B32B 2413/00; D03D 1/00

(57) ABSTRACT

The present invention provides for manufacturing processes of structuring fabrics that contain a web contacting layer with seams that do not cause defects in the sheet that can result in sheet breaks during the paper machine process. Structuring fabrics with a web contacting layer that can have damaged sections replaced rather than replacing the entire structuring fabric, which is costly and time consuming, are also provided. Additionally, a process for manufacturing the web contacting layer by laying down polymers of specific material properties in an additive manner under computer control (3-D printing) is provided.

### RELATED APPLICATIONS

This application claims priority to and the benefit of U.S. Provisional Application No. 62/960,763, filed Jan. 14, 2020 and entitled FABRIC INCLUDING REPAIRABLE POLYMERIC LAYER WITH SEAM FOR PAPERMAKING MACHINE, and this application also claims priority to and the benefit of U.S. Provisional Application No. 62/897,596, filed Sep. 9, 2019 and entitled FABRIC INCLUDING REPAIRABLE POLYMERIC LAYER WITH NOVEL SEAM FOR PAPERMAKING MACHINE, the contents of which are incorporated herein by reference in their entirety.

### FIELD OF THE INVENTION

This disclosure relates to processes for manufacturing fabrics or belts for a papermaking machine, and in particular to fabrics or belts that include polymeric layers and that are intended for use on papermaking machines for the production of tissue products.

### BACKGROUND

Tissue manufacturers that can deliver the highest quality product at the lowest cost have a competitive advantage in the marketplace. A key component in determining the cost and quality of a tissue product is the manufacturing process utilized to create the product. For tissue products, there are several manufacturing processes available including conventional dry crepe, through air drying (TAD), or “hybrid” technologies such as Valmet's NTT and QRT processes, Georgia Pacific's ETAD, and Voith's ATMOS process. Each has differences as to installed capital cost, raw material utilization, energy cost, production rates, and the ability to generate desired attributes such as softness, strength, and absorbency.

Conventional manufacturing processes include a forming section designed to retain the fiber, chemical, and filler recipe while allowing the water to drain from the web. Many types of forming sections, such as a flat fourdrinier, inclined suction breast roll, twin wire C-wrap, twin wire S-wrap, suction forming roll, and Crescent formers, include the use of forming fabrics.

Forming fabrics are woven structures that utilize monofilaments (such as yarns or threads) composed of synthetic polymers (usually polyethylene terephthalate, or nylon). A forming fabric has two surfaces, the sheet side and the machine or wear side. The wear side is in contact with the elements that support and move the fabric and are thus prone to wear. To increase wear resistance and improve drainage, the wear side of the fabric has larger diameter monofilaments compared to the sheet side. The sheet side has finer yarns to promote fiber and filler retention on the fabric surface.

Different weave patterns are utilized to control other properties such as: fabric stability, life potential, drainage, fiber support, and clean-ability. There are three basic types of forming fabrics: single layer, double layer, and triple layer. A single layer fabric is composed of one yarn system made up of cross direction (CD) yarns (also known as shute yarns) and machine direction (MD) yarns (also known as warp yarns). The main issue for single layer fabrics is a lack of dimensional stability. A double layer forming fabric has one layer of warp yarns and two layers of shute yarns. This multilayer fabric is generally more stable and resistant to stretching. Triple layer fabrics have two separate single layer fabrics bound together by separated yarns called binders. Usually the binder fibers are placed in the cross direction but can also be oriented in the machine direction. Triple layer fabrics have further increased dimensional stability, wear potential, drainage, and fiber support than single or double layer fabrics.

The manufacturing of forming fabrics includes the following operations: weaving, initial heat setting, seaming, final heat setting, and finishing. The fabric is made in a loom using two interlacing sets of monofilaments (or threads or yarns). The longitudinal or machine direction threads are called warp threads and the transverse or cross machine direction threads are called shute threads. After weaving, the forming fabric is heated to relieve internal stresses, which in turn enhances dimensional stability of the fabric. The next step in manufacturing is seaming. This step converts the flat woven fabric into an endless forming fabric by joining the two MD ends of the fabric. After seaming, a final heat setting is applied to stabilize and relieve the stresses in the seam area. The final step in the manufacturing process is finishing, whereby the fabric is cut to width and sealed.

There are several parameters and tools used to characterize the properties of the forming fabric: mesh and count, caliper, frames, plane difference, open area, air permeability, void volume and distribution, running attitude, fiber support, drainage index, and stacking. None of these parameters can be used individually to precisely predict the performance of a forming fabric on a paper machine, but together the expected performance and sheet properties can be estimated. Examples of forming fabric designs can be viewed in U.S. Pat. Nos. 3,143,150, 4,184,519, 4,909,284, and 5,806,569.

In a conventional dry crepe process, after web formation and drainage (to around 35% solids) in the forming section (assisted by centripetal force around the forming roll and, in some cases, vacuum boxes), a web is transferred from the forming fabric to a press fabric upon which the web is pressed between a rubber or polyurethane covered suction pressure roll and a Yankee dryer. The press fabric is a permeable fabric designed to uptake water from the web as it is pressed in the press section. It is composed of large monofilaments or multi-filamentous yarns, needled with fine synthetic batt fibers to form a smooth surface for even web pressing against the Yankee dryer. Removing water via pressing reduces energy consumption.

In a conventional TAD process, rather than pressing and compacting the web, as is performed in conventional dry crepe, the web undergoes the steps of imprinting and thermal pre-drying. Imprinting is a step in the process where the web is transferred from a forming fabric to a structured fabric (or imprinting fabric) and subsequently pulled into the structured fabric using vacuum (referred to as imprinting or molding). This step imprints the weave pattern (or knuckle pattern) of the structured fabric into the web. This imprinting step increases softness of the web, and affects smoothness and the bulk structure. The manufacturing method of an imprinting fabric is similar to a forming fabric (see U.S. Pat. Nos. 3,473,576, 3,573,164, 3,905,863, 3,974,025, and 4,191,609 for examples) except for an additional step of overlaying a polymer.

Imprinting fabrics with an overlaid polymer are disclosed in U.S. Pat. Nos. 5,679,222, 4,514,345, 5,334,289, 4,528,239 and 4,637,859. Specifically, these patents disclose a method of forming a fabric in which a patterned resin is applied over a woven substrate. The patterned resin completely penetrates the woven substrate. The top surface of the patterned resin is flat and openings in the resin have sides that follow a linear path as the sides approach and then penetrate the woven structure. Another technique used to apply an overlaid resin to a woven imprinting fabric is found in U.S. Pat. Nos. 6,610,173, 6,660,362, 6,998,017, and European Patent EP 1339915, and involves the use of an overlaid polymer that has an asymmetrical cross sectional profile in at least one of the machine direction and a cross direction and at least one nonlinear side relative to the vertical axis. The top portion of the overlaid resin can be a variety of shapes and not simply a flat structure. The sides of the overlaid resin, as the resin approaches and then penetrates the woven structure, can also take different forms, not a simple linear path 90 degrees relative the vertical axis of the fabric. Both methods result in a patterned resin applied over a woven substrate. The benefit is that resulting patterns are not limited by a woven structure and can be created in any desired shape to enable a higher level of control of the web structure and topography that dictate web quality properties.

After imprinting, the web is thermally pre-dried by moving hot air through the web while it is conveyed on the structured fabric. Thermal pre-drying can be used to dry the web to over 90% solids before the web is transferred to a steam heated cylinder. The web is then transferred from the structured fabric to the steam heated cylinder through a very low intensity nip (up to 10 times less than a conventional press nip) between a solid pressure roll and the steam heated cylinder. The portions of the web that are pressed between the pressure roll and steam cylinder rest on knuckles of the structured fabric, thereby protecting most of the web from the light compaction that occurs in this nip. The steam heated cylinder and an optional air cap system, for impinging hot air, then dry the sheet to up to 99% solids during the drying stage before creping occurs. The creping step of the process again only affects the knuckle sections of the web that are in contact with the steam heated cylinder surface. Due to only the knuckles of the web being creped, along with the dominant surface topography being generated by the structured fabric, and the higher thickness of the TAD web, the creping process has a much smaller effect on overall softness as compared to conventional dry crepe. After creping, the web is optionally calendared and reeled into a parent roll and ready for the converting process. Some TAD machines utilize fabrics (similar to dryer fabrics) to support the sheet from the crepe blade to the reel drum to aid in sheet stability and productivity. Patents which describe creped through air dried products include U.S. Pat. Nos. 3,994,771, 4,102,737, 4,529,480, and 5,510,002.

The TAD process generally has higher capital costs as compared to a conventional tissue machine due to the amount of air handling equipment needed for the TAD section. Also, the TAD process has a higher energy consumption rate due to the need to burn natural gas or other fuels for thermal pre-drying. However, the bulk softness and absorbency of a paper product made from the TAD process is superior to conventional paper due to the superior bulk generation via structured fabrics, which creates a low density, high void volume web that retains its bulk when wetted. The surface smoothness of a TAD web can approach that of a conventional tissue web. The productivity of a TAD machine is less than that of a conventional tissue machine due to the complexity of the process and the difficulty of providing a robust and stable coating package on the Yankee dryer needed for transfer and creping of a delicate pre-dried web.

UCTAD (un-creped through air drying) is a variation of the TAD process in which the sheet is not creped, but rather dried up to 99% solids using thermal drying, blown off the structured fabric (using air), and then optionally calendared and reeled. U.S. Pat. No. 5,607,551 describes an uncreped through air dried product.

A process/method and paper machine system for producing tissue has been developed by the Voith company and is marketed under the name ATMOS. The process/method and paper machine system has several variations, but all involve the use of a structured fabric in conjunction with a belt press. The major steps of the ATMOS process and its variations are stock preparation, forming, imprinting, pressing (using a belt press), creping, calendaring (optional), and reeling the web.

The stock preparation step of the ATMOS process is the same as that of a conventional or TAD machine. The forming process can utilize a twin wire former (as described in U.S. Pat. No. 7,744,726), a Crescent Former with a suction Forming Roll (as described in U.S. Pat. No. 6,821,391), or a Crescent Former (as described in U.S. Pat. No. 7,387,706). The former is provided with a slurry from the headbox to a nip formed by a structured fabric (inner position/in contact with the forming roll) and forming fabric (outer position). The fibers from the slurry are predominately collected in the valleys (or pockets, pillows) of the structured fabric and the web is dewatered through the forming fabric. This method for forming the web results in a bulk structure and surface topography as described in U.S. Pat. No. 7,387,706 (FIGS. 1-11). After the forming roll, the structured and forming fabrics separate, with the web remaining in contact with the structured fabric.

The web is now transported on the structured fabric to a belt press. The belt press can have multiple configurations. The press dewaters the web while protecting the areas of the sheet within the structured fabric valleys from compaction. Moisture is pressed out of the web, through the dewatering fabric, and into the vacuum roll. The press belt is permeable and allows for air to pass through the belt, web, and dewatering fabric, and into the vacuum roll, thereby enhancing the moisture removal. Since both the belt and dewatering fabric are permeable, a hot air hood can be placed inside of the belt press to further enhance moisture removal. Alternately, the belt press can have a pressing device which includes several press shoes, with individual actuators to control cross direction moisture profile, or a press roll. A common arrangement of the belt press has the web pressed against a permeable dewatering fabric across a vacuum roll by a permeable extended nip belt press. Inside the belt press is a hot air hood that includes a steam shower to enhance moisture removal. The hot air hood apparatus over the belt press can be made more energy efficient by reusing a portion of heated exhaust air from the Yankee air cap or recirculating a portion of the exhaust air from the hot air apparatus itself.

After the belt press, a second press is used to nip the web between the structured fabric and dewatering felt by one hard and one soft roll. The press roll under the dewatering fabric can be supplied with vacuum to further assist water removal. This belt press arrangement is described in U.S. Pat. Nos. 8,382,956 and 8,580,083, with FIG. 1 showing the arrangement. Rather than sending the web through a second press after the belt press, the web can travel through a boost dryer, a high pressure through air dryer, a two pass high pressure through air dryer or a vacuum box with hot air supply hood. U.S. Pat. Nos. 7,510,631, 7,686,923, 7,931,781, 8,075,739, and 8,092,652 further describe methods and systems for using a belt press and structured fabric to make tissue products each having variations in fabric designs, nip pressures, dwell times, etc., and are mentioned here for reference. A wire turning roll can be also be utilized with vacuum before the sheet is transferred to a steam heated cylinder via a pressure roll nip.

The sheet is now transferred to a steam heated cylinder via a press element. The press element can be a through drilled (bored) pressure roll, a through drilled (bored) and blind drilled (blind bored) pressure roll, or a shoe press. After the web leaves this press element and before it contacts the steam heated cylinder, the % solids are in the range of 40-50%. The steam heated cylinder is coated with chemistry to aid in sticking the sheet to the cylinder at the press element nip and also to aid in removal of the sheet at the doctor blade. The sheet is dried to up to 99% solids by the steam heated cylinder and an installed hot air impingement hood over the cylinder. This drying process, the coating of the cylinder with chemistry, and the removal of the web with doctoring is explained in U.S. Pat. Nos. 7,582,187 and 7,905,989. The doctoring of the sheet off the Yankee, i.e., creping, is similar to that of TAD with only the knuckle sections of the web being creped. Thus, the dominant surface topography is generated by the structured fabric, with the creping process having a much smaller effect on overall softness as compared to conventional dry crepe. The web is then calendared (optional), slit, reeled and ready for the converting process.

The ATMOS process has capital costs between that of a conventional tissue machine and a TAD machine. It uses more fabrics and a more complex drying system compared to a conventional machine, but uses less equipment than a TAD machine. The energy costs are also between that of a conventional and a TAD machine due to the energy efficient hot air hood and belt press. The productivity of the ATMOS machine has been limited due to the inability of the novel belt press and hood to fully dewater the web and poor web transfer to the Yankee dryer, likely driven by poor supported coating packages, the inability of the process to utilize structured fabric release chemistry, and the inability to utilize overlaid fabrics to increase web contact area to the dryer. Poor adhesion of the web to the Yankee dryer has resulted in poor creping and stretch development which contributes to sheet handling issues in the reel section. The result is that the output of an ATMOS machine is currently below that of conventional and TAD machines. The bulk softness and absorbency is superior to conventional, but lower than a TAD web since some compaction of the sheet occurs within the belt press, especially areas of the web not protected within the pockets of the fabric. Also, bulk is limited since there is no speed differential to help drive the web into the structured fabric as exists on a TAD machine. The surface smoothness of an ATMOS web is between that of a TAD web and a conventional web primarily due to the current limitation on use of overlaid structured fabrics.

The ATMOS manufacturing technique is often described as a hybrid technology because it utilizes a structured fabric like the TAD process, but also utilizes energy efficient means to dewater the sheet like the conventional dry crepe process. Other manufacturing techniques which employ the use of a structured fabric along with an energy efficient dewatering process include the ETAD, NTT and QRT processes. The ETAD process and products are described in U.S. Pat. Nos. 7,339,378, 7,442,278, and 7,494,563. The NTT process and products are described in WO 2009/061079 A1, United States Patent Application Publication No. 2011/0180223 A1, and United States Patent Application Publication No. 2010/0065234 A1. The QRT process is described in United States Patent Application Publication No. 2008/0156450 A1 and U.S. Pat. No. 7,811,418. A structuring belt manufacturing process used for the NTT, QRT, and ETAD imprinting process is described in U.S. Pat. No. 8,980,062 and United States Patent Application Publication No. US 2010/0236034.

The NTT process involves spirally winding strips of polymeric material, such as industrial strapping or ribbon material, and adjoining the sides of the strips of material using ultrasonic, infrared, or laser welding techniques to produce an endless belt. Optionally, a filler or gap material can be placed between the strips of material and melted using the aforementioned welding techniques to join the strips of materials. The strips of polymeric material are produced by an extrusion process from any polymeric resin such as polyester, polyamide, polyurethane, polypropylene, or polyether ether ketone resins. The strip material can also be reinforced by incorporating monofilaments of polymeric material into the strips during the extrusion process or by laminating a layer of woven polymer monofilaments to the non-sheet contacting surface of a finished endless belt composed of welded strip material. The endless belt can have a textured surface produced using processes such as sanding, graving, embossing, or etching. The belt can be impermeable to air and water, or made permeable by processes such as punching, drilling, or laser drilling. Examples of structuring belts used in the NTT process can be viewed in International Publication Number WO 2009/067079 A1 and United States Patent Application Publication No. 2010/0065234 A1.

As shown in the aforementioned discussion of tissue papermaking technologies, the fabrics or belts utilized are critical in the development of the tissue web structure and topography which, in turn, are instrumental in determining the quality characteristics of the web such as softness (bulk softness and surfaces smoothness) and absorbency. The manufacturing process for making these fabrics has been limited to weaving a fabric (primarily forming fabrics and structured fabrics) or a base structure and needling synthetic fibers (press fabrics) or overlaying a polymeric resin (overlaid structured fabrics) to the fabric/base structure, or welding strips of polymeric material together to form an endless belt.

Conventional overlaid structures require application of an uncured polymer resin over a woven substrate where the resin completely penetrates through the thickness of the woven structure. Certain areas of the resin are cured and other areas are uncured and washed away from the woven structure. This results in a fabric where airflow through the fabric is only possible in the Z-direction. Thus, in order for the web to dry efficiently, only highly permeable fabrics can be utilized, meaning the amount of overlaid resin applied needs to be limited. If a fabric of low permeability is produced in this manner, then drying efficiency is significantly reduced, resulting in poor energy efficiency and/or low production rates as the web must be transported slowly across the TAD drums or ATMOS drum for sufficient drying. Similarly, a welded polymer structuring layer is extremely planar and provides an even surface when laminating to a woven support layer, which prevents air from flowing in the X-Y plane.

As described in U.S. Pat. No. 10,208,426 B2, the contents of which are hereby incorporated by reference in their entirety, fabrics may be formed by laminating an extruded polymer netting to a woven structure. Both the extruded polymer netting layer and woven layer have non-planar, irregularly shaped surfaces that when laminated together only bond together where the two layers come into direct contact. This provides air channels in the X-Y plane of the fabric through which air can travel when the sheet is being dried with hot air in the TAD, UCTAD, or ATMOS process. The airflow path and dwell time is longer through this type of fabric allowing the air to remove higher amounts of water compared to prior designs. This allows for the use of lower permeable belts compared to prior fabrics without increasing the energy demand per ton of paper dried. The air flow in the X-Y plane also reduces high velocity air flow in the Z-direction as the sheet and fabric pass across the molding box, reducing the ability to form pin holes in the sheet.

There is a need for improved structuring fabrics and methods for making them.

### SUMMARY OF THE INVENTION

An object of the present invention is to provide for manufacturing processes of structuring fabrics that contain a web contacting layer with seams, otherwise referred to herein as splices, that do not cause defects in the sheet, which might otherwise result in sheet breaks during the papermaking process.

Another object of the present invention is to provide structuring fabrics with a web contacting layer that can have damaged sections replaced, thereby obviating the need to replace the entire structuring fabric, which is costly and time consuming.

Another object of the present inventon is to provide a process for manufacturing a web contacting layer of a structuring fabric by laying down polymers of specific material properties in an additive manner under computer control.

According to an exemplary embodiment of the present invention, a method of forming a structured papermaking fabric comprises: printing a thermosetting polymer blend onto a non-stick film in a pattern; removing the thermosetting polymer blend from the non-stick film, the removed thermosetting polymer blend forming a web-contacting layer of the structured papermaking fabric; and laminating the web-contacting layer to a woven fabric to form the structured papermaking fabric.

According to an exemplary embodiment, the method further comprises the step of curing the thermosetting polymer blend.

According to an exemplary embodiment, the thermosetting polymer blend comprises from 10% to 85% by weight photopolymer and the step of curing comprises use of ultraviolet light. Curing of thermoset resin can occur during or after lamination to ensure good bonding and hardness. Curing of photopolymer can be delayed by coating the 3-D printed web in energy shielding material to prevent curing until after lamination or installation on the paper machine.

According to an exemplary embodiment, the thermosetting polymer blend comprises a polymer selected from the group consisting of polybutylene terephthalate, polyester, polyamide, polyurethane, polypropylene, polyethylene, polyethylene terephthalate, polyether ether ketone resins and combinations thereof.

According to an exemplary embodiment, the non-stick film is biaxially-oriented polyethylene terephthalate.

According to an exemplary embodiment, the step of laminating comprises at least one of adhesive or welding.

According to an exemplary embodiment, the welding is laser welding.

According to an exemplary embodiment, the step of laminating comprises forming distinct bonds that are spaced apart.

According to an exemplary embodiment, the bonds have a length of 10 mm or less, or more preferably 5 mm or less, more preferably 0.1 mm to 3 mm, or more preferably 0.15 mm to 2.8 mm, and most preferably 0.16 mm to 2.6 mm.

According to an exemplary embodiment, the removed and cured thermosetting polymer blend forms a strip comprising a first end and a second end, and the method further comprises spirally winding the strip onto the woven fabric.

According to an exemplary embodiment, the step of spirally winding comprises forming a seam between the first and second ends.

According to an exemplary embodiment, the seam extends at a 0° to 90° angle relative to a machine direction of the fabric.

According to an exemplary embodiment, the seam extends at a 5° to 85° angle relative to a machine direction of the fabric.

According to an exemplary embodiment, the method further comprises the step of forming first structures at the first end and second structures at the second end, where the first structures at least one of abut, overlap or interlock with the second structures to form the seam.

According to an exemplary embodiment, the first and second structures form lock-and-key structures.

According to an exemplary embodiment, the imprinting belt comprises bonds between layers of 5 mm or less in any direction.

### BRIEF DESCRIPTION OF THE DRAWINGS

The features and advantages of exemplary embodiments of the present invention will be more fully understood with reference to the following, detailed description when taken in conjunction with the accompanying figures, wherein:

FIG. 1 is an apparatus for 3 D printing a papermaking belt according to an exemplary embodiment of the present invention;

FIG. 2 is an apparatus for laminating layers of a papermaking belt according to an exemplary embodiment of the present invention;

FIG. 3 is a cross-section view of a papermaking belt according to an exemplary embodiment of the present invention;

FIG. 4 is perspective view of a papermaking belt according to an exemplary embodiment of the present invention;

FIG. 5 shows a process for spirally winding papermaking belts according to an exemplary embodiment of the present invention;

FIG. 6 shows a web-supporting layer seam according to an exemplary embodiment of the present invention;

FIG. 7 shows a web-supporting layer seam with overlapping structures according to an exemplary embodiment of the present invention;

FIG. 8 shows a web-supporting layer seam with lock and key structures according to an exemplary embodiment of the present invention;

FIG. 9 shows a belt with a visually and chemically distinct continuous and repeating pattern according to an exemplary embodiment of the present invention;

FIG. 10 is a photograph of belt interlocking structures according to an exemplary embodiment of the present invention;

FIG. 11 is a photograph of belt interlocking structures on edges of a belt according to an exemplary embodiment of the present invention;

FIG. 12 shows a seam of a web contacting layer according to an exemplary embodiment of the present invention;

FIG. 13 is a differential scanning calorimeter scan of a thermoplastic elastomer netting according to an exemplary embodiment of the present invention;

FIG. 14 shows a bonding pattern of laminates according to an exemplary embodiment of the present invention;

FIGS. 15 and 16 show the formation of components in the interface between the web contacting layer and the support layer that extend in the z-direction (i.e., up and around the individual elements of the web contacting layer), in addition to the x- and y-directions that occur during the bonding process, according to an exemplary embodiment of the present invention;

FIG. 17 shows a damaged section of laminated fabric with the top web contacting layer being separated from the bottom support layer; and

FIG. 18 shows the damaged section of the laminated fabric of FIG. 17 repaired using a patch and solvent method according to an exemplary embodiment of the present invention.

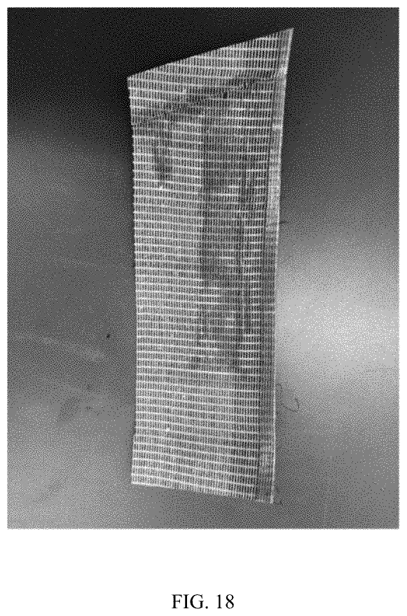

### DETAILED DESCRIPTION

In order to manufacture a fabric of the size and variety described in U.S. Pat. No. 10,208,426, it would be preferred to laminate a web contacting layer that is the same width as the supporting woven layer, which is the same width required for the production of the paper on a papermaking machine. The web contacting layer is sometimes referred to as a “scrim”. Typical widths of fabrics used on papermaking machines can be less than 240 inches (general machine sizes are 110 inches fabric and 220 inches fabric but as large as 310 do exist), and equipment to produce a web contacting layer of an extruded polymer sheet (that is then engraved, embossed, or laser drilled), extruded polymer netting, or 3-D printed sheet within this width range is currently limited.

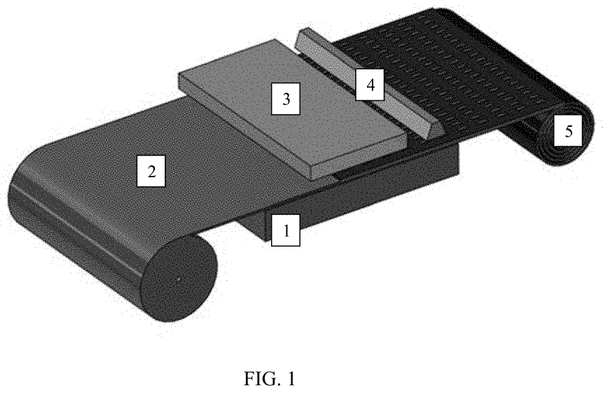

As an alternative to using a web contacting layer that is full machine width, a spiral winding (FIG. 1) of a strip of extruded polymer netting, a laser engraved polymer strip, or 3-D printed strip can be laminated onto a supporting woven layer using adhesives, infrared, ultrasonic, ultraviolet, laser, solvent or other bonding techniques. A drawback to this method is that a seam is produced that extends in the machine direction of the fabric. Seams can cause marks or defects in the paper web which are noticeable to the end consumer and typically are the source of sheet breaks on the papermaking machines, which cause machine downtime.

U.S. Pat. No. 10,099,425, the contents of which are hereby incorporated by reference in their entirety, describes a papermaking fabric or belt made using material laid down successively using a 3D printing process. As the patent describes, 3-D printing technologies require depositing material for an entire layer in the X-Y (length and width) plane completely before indexing in the Z (thickness) direction and depositing each successive layer in the X-Y plane. Additionally, support material is required in the printing process, which must then be removed from the finished object. In exemplary embodiments, the present invention allows for 3-D printing of successive layers of material in the Z-direction, e.g., up to 10 mm in thickness, without the use of support material and without the need to complete an entire layer in the X-Y plane. Therefore, the object does not need to have the entire layer of each X-Y plane printed to completion before printing in the Z-direction.

The various belts used in the papermaking process are nearly all less than 10 mm (millimeters) in thickness. Conventionally, in order to print a papermaking fabric up to 10 mm in thickness, successive rows of print heads would need to be utilized that deposit a layer of material on top of a layer of material deposited by the previous print head. Additionally, means to index and support the printed fabric from one print head to the next, until the full thickness of the fabric is reached, would be required. This would require potentially restrictive amounts of capital to purchase a large number of print heads. If multiple rows of print heads were not utilized, then the entire machine length and cross direction width of the fabric would need to be printed, then supported and indexed back to the print head repeatedly until the entire Z-direction thickness of the fabric is completed. This would require a structure having at least the same size as that of the fabric to support the fabric as it travels repeatedly through the single print head. With fabrics generally being over 6 meters in the cross direction and greater than 70 meters in the machine direction, such a support apparatus would be cost restrictive and very complicated. Additionally, a means to remove the printed support material would need to be integrated in both methods.

The complexity of the printing method and apparatus, as well as the cost of the method or apparatus declines significantly when support material is not required and the entirety of the object in the Z-direction can be printed before completion of printing of the object in the X-Y plane. In order to accomplish this, a unique blend of polymers is utilized in a PolyJet 3-D print head, where these polymers are strong enough to maintain dimensional stability without the need of any support material when printed less than 10 millimeters in thickness. Additionally, at least some polymers of the polymer blend are not photopolymers and remain thermoplastic after exposure to ultraviolet light. The remainder of the polymers are photopolymers and are thermoset after printing and curing with UV light. Preferably up to 50% of the polymers are photopolymers, more preferably between 65% to 85%, and most preferably, between 70% to 80%. The unique polymer blend allows for the printed material to be printed up to 10 mm in thickness and indexed using a support apparatus in the X-Y plane, while retaining the ability to bond after curing using ultraviolet light. The non-crosslinked polymer content in the polymer blend remains uncured after exposure to UV light to allow for lamination and seam bonding if used as a layer in a multilayer composite fabric, such as the web contacting layer in an imprinting fabric laminated to a woven supporting layer. All polymers in the blend are preferably thermostable when heated to a temperature of 65-250° C., more preferably to a temperature of 80-200° C., and even more preferably to a temperature of 90-180° C. As used herein, “thermostable” means that the material does not burn, disintegrate, decompose, lose integrity, delaminate, or lose adhesion within the given temperature range. Additionally, the co-polymer matrix remains in the solid state up to 200° C. before becoming plastic. The goal is to enhance bonding between the plys by fusing the two plys together during lamination (to form “lamination bonds”). Higher thermal stability can reduce polymer flexibility which can create a laminated matrix that is too rigid or brittle. In exemplary embodiments, the present invention provides a range where the matrix remains flexible and thermally stable. This matrix is created by fusing two different types of polymer sheets together. Co-polymer blends are used in each layer (woven or extruded netting, 3-D printed layer, cast or extruded film with cut holes), and the two layers are bonded together to provide a flexible imprinting layer.

FIG. 1 shows an apparatus for forming a belt or fabric according to an exemplary embodiment of the present invention. The apparatus includes a support table 1 across which a non-stick layer 2, such as such as Mylar film, is indexed. Mylar, also known as BoPET (Biaxially-oriented polyethylene terephthalate) is a polyester film made from stretched polyethylene terephthalate (PET) and is used for its high tensile strength, and chemical and dimensional stability. Other films can be used if they are non-stick and they are able to maintain dimensional stability such that when stretched onto a support table there is no measureable change (less than 5 micron) in the distance between any area of the film and the print head lying directly above that area of the film. Maintaining this distance is important for accurate printing from the print head onto the film. Other suitable non-stick films include polytetrafluorethylene (TEFLON), silicone treated films and the like. As used herein, the term “non-stick” refers to a material having a surface energy between about 10 mj/m² to about 200 mj/m².

The support table 1 and non-stick layer 2 have at least the same width as the required cross-direction width of the fabric or web-contacting layer of a composite fabric being printed. A PolyJet print head 3 deposits/prints the polymer blend to the required and final thickness in the Z-direction from one edge of the Mylar film to the other edge in the cross direction (X direction) before proceeding to index the Mylar film in the machine direction (Y direction) to the adjacent section of Mylar film. This process is repeated until the entire required area is complete. Again, the polymer blend is substantially thermoplastic and able to bond to the adjacent section of printed polymer prior to exposure to the subsequent step of ultraviolet curing. As the Mylar film and deposited material is indexed, it will then travel through an ultraviolet head 4 to cure and bond the photopolymers in the polymer blend. The polymers in the blend that are not photosensitive remain thermoplastic but remain in the solid state below 200° Celsius. The Mylar film and printed polymer film is wound into a roll form 5. If creating a belt comprised of just this printed film, the Mylar can later be removed from the printed polymer film, and the ends of the polymer film are then seamed together using a laser, infrared, ultrasonic, solvent welding, adhesive methods or combinations thereof to create a seamed and endless belt or fabric ready to be utilized directly on the papermaking machine. The Mylar or non-stick film may be structured (may have 3 dimensional topography) by, for example, embossing the film to have raised mid-rib like structures creating a three dimensional image with back-side air flow.

In an exemplary embodiment, the ends of the fabric to be seamed are printed at an angle with abutting, overlapping, interlocking, and/or lock and key structures to create a strong, non-marking seam.

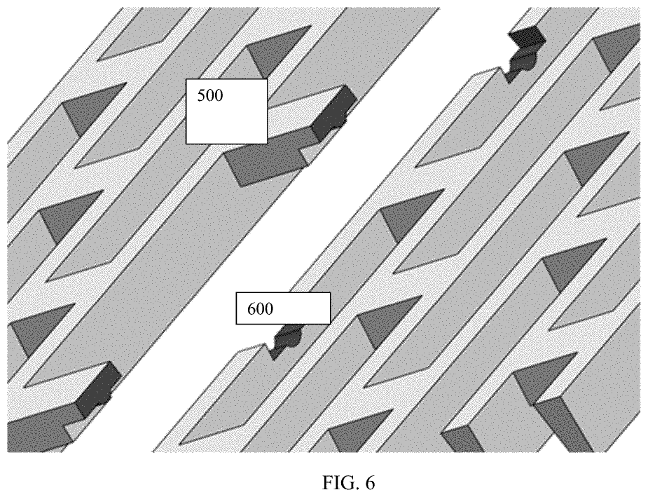

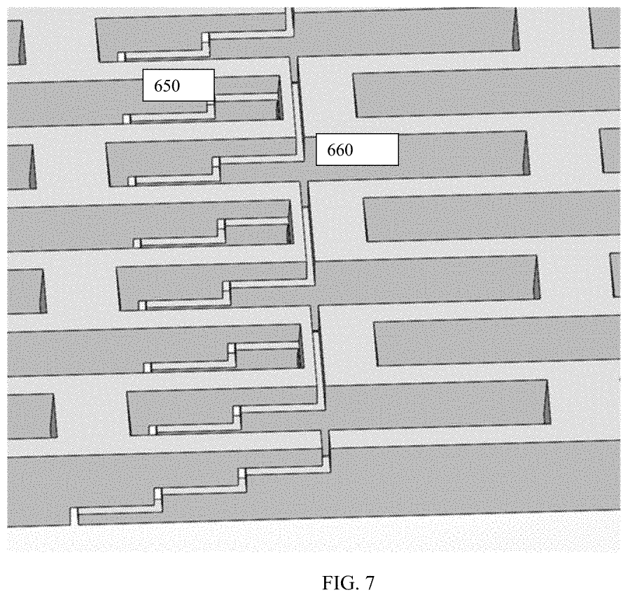

FIGS. 6 and 7 show overlapping structures 500, 600 and 650, 660 which provide large surface areas for increased bond area and thus enhanced seam strength after the seaming and lamination process. An overlapping structure in a seam may be defined as an area where one end of the fabric (or film) covers or extends over the second end of the fabric (or film).

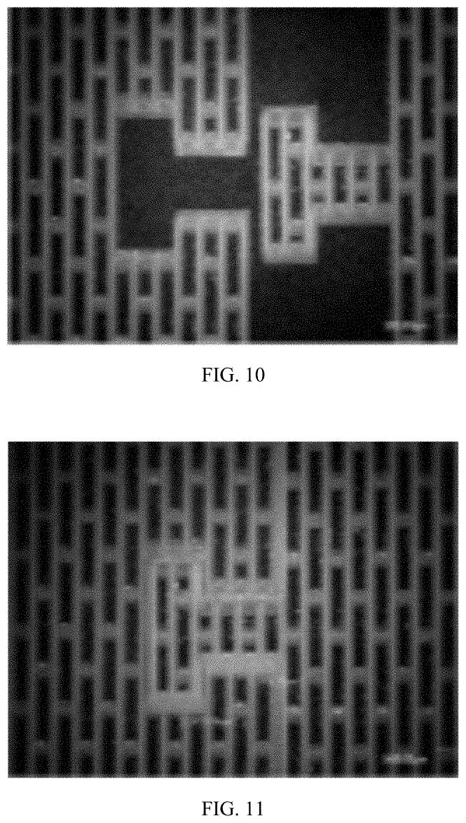

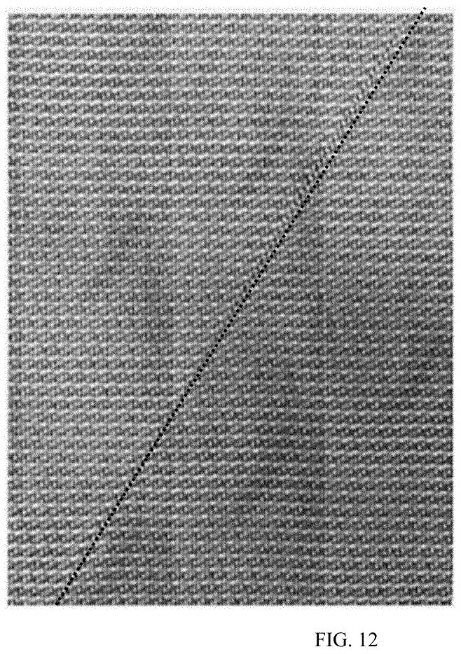

FIGS. 10 and 11 show interlocking structures which can be used as an alternative or in addition to overlapping structures. An interlocking structure can be printed into the ends of the polymer film. An interlocking structure in a seam may be defined as a projection from one end of the fabric that connects into a recessed portion of the second end of the fabric. Interlocking structures are especially useful for aiding in alignment of the ends during the seaming/seam bonding process. Examples of interlocking structures include, but are not limited to, snap fit structures and dove tailed structures/joints. FIG. 10 shows an example of interlocking structures on the edges of the web contacting layer of the fabric prior to alignment and seam bonding. FIG. 11 shows an example of interlocking structures on the edges of the web contacting layer of the fabric after alignment and seam bonding. It is preferable to keep the seam width below 1.5 mm, or below 0.9 mm, or below 0.7 mm. The seam width is important as too large of a seam will prevent fibers in the web from being able to bridge the width of the seam. If the fiber cannot bridge over the seam, the fibers tend to be pulled off the seam, onto the web supporting layer, which then leaves a void space in the web, which leads to weak points and sheet breaks. For example, typical wood fiber lengths range between 1.0 to 3.0 mm.

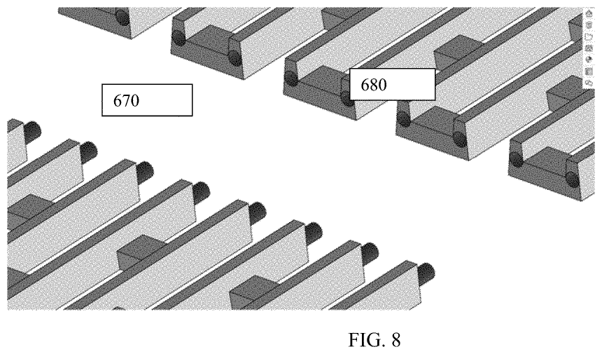

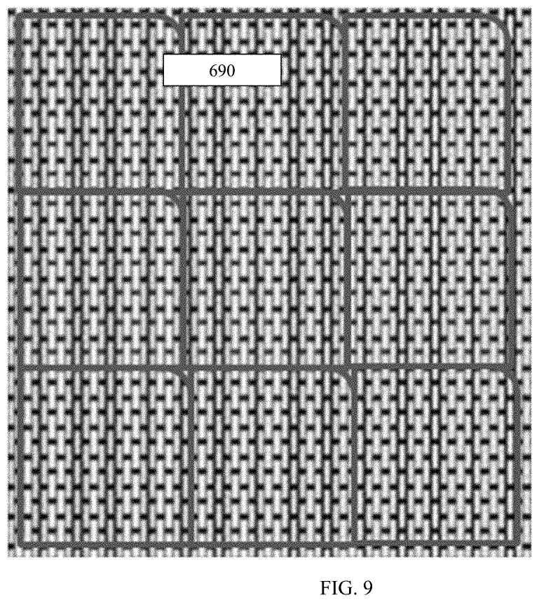

FIGS. 8 and 9 show lock and key structures, which include key structures 670 formed at one end of the fabric that are inserted on to or in to lock structures 680 formed at the second end of the fabric, resulting in the key structure being at least partially enclosed in the lock structure. Specifically, FIG. 9 shows an example of a visually and chemically distinct continuous and repeating pattern comprised of cross-linked co-polymer resin in a web contacting layer of a structuring fabric 690 formed using 3-D printing techniques.

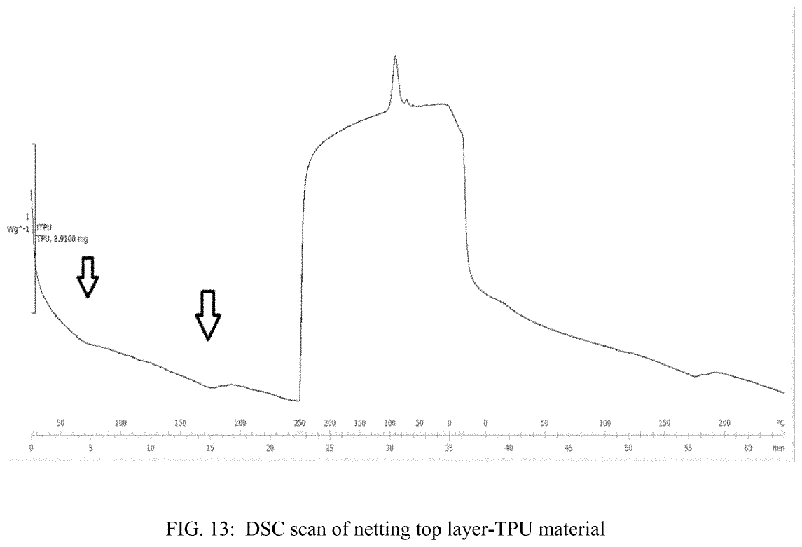

Combining abutting, overlapping, interlocking, and lock and key structures could provide for a seam/that is stronger and more resilient than a seam using only one of these structures. Seams formed by such structures are preferably angled such that any weak points in the paper web caused by the seam are not in alignment with the machine or cross machine direction where stresses in the web are at their peak. In this regard, seam angles are preferably tangential to the machine direction at an angle ranging from 0° to 90°, 5° to 85°, or 10° to 70°, or 40° to 70° or 60°. FIG. 12 shows an example of a section of a web contacting layer from a full machine width composite fabric where the web contacting layer has been laser cut in the cross direction at an angle of approximately 60 degrees to machine direction prior to alignment, seam/splice bonding, and lamination to the woven supporting layer.

After aligning the two ends of the printed polymer film that contain one or all of these structures, energy from an infrared or laser device may be applied to the seam area to heat the material above 200° C., at which point the thermoplastic polymer materials in the film become plastic and overlap and/or intermix. The seam area is then cooled below 200° C., whereby the thermoplastic polymers return to the solid state to create a unitary, bonded seam or splice. To improve seam bonding, an activator can be applied to the overlapping, interlocking, and/or lock and key structures prior to heating such that additional energy is absorbed by the activator to ensure the seamed area is heated in its entirety, to provide for maximum bonded area. Ultrasonic energy might be applied separately or in conjunction with infrared or laser energy to plasticize the thermoplastic polymers and form the seam. Solvent bonding can also be used as explained in subsequent exemplary embodiments.

In an embodiment, a non-woven tissue making fabric includes a plurality of substantially parallel adjoining sections of non-woven material having a width less than the width of the non-woven tissue making fabric, the sections being joined together to form a non-woven tissue making fabric of sufficient strength and permeability to be suitable for use as a through-drying fabric, a forming fabric, or an imprinting fabric. The plurality of sections of nonwoven material may comprise a single fabric strip that is repeatedly wrapped in a substantially spiral manner to form parallel adjacent sections that can abut one another or overlap one another in successive turns to form a continuous loop of non-woven tissue making fabric having a width substantially greater than the width of the fabric strip of non-woven material. When a single fabric strip wrapped in a spiral manner is bonded to itself in regions of overlap for adjacent sections of the strip, the non-woven tissue making fabric is said to have a spirally continuous seam. In such a non-woven tissue making fabric, wherein each fabric strip of non-woven material has a first edge and an opposing second edge, the fabric strip of non-woven material is spirally wound in a plurality of contiguous turns such that the first edge in a turn of the fabric strip abuts with or extends beyond the second edge of an adjacent turn of the fabric strip, forming a spirally continuous seam with adjacent turns of the fabric strip. The non-woven fabric strip of the non-woven material may have a width ranging between about 1 inch and about 600 inches; between about 1 inch and about 300 inches; between about 2 inches and about 100 inches; between about 2 inches and about 50 inches; and, between about 3 inches and about 20 inches, or may have a width of about 12 inches or less, or a width of about 6 inches or less. In some embodiments of the present invention, the non-woven fabric strip of the non-woven material may have a width ranging between about 30 to about 100 inches. The non-woven fabric may be wound onto and bonded with a support woven fabric or carrier woven fabric.

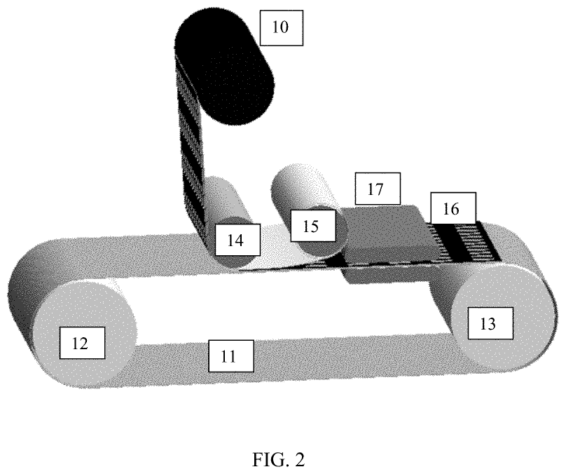

FIG. 2 shows an apparatus for forming a belt or fabric according to another exemplary embodiment of the present invention. The apparatus in this embodiment is suitable for creating a multilayer belt such that the printed film becomes the web contacting layer laminated to a supporting layer (such as a woven layer comprised of sanded or unsanded, round or shaped, monofilaments or a woven layer comprised of these types of monofilaments and multi-filamentous yarns needled with fine synthetic batt fibers). As shown in FIG. 2, the Mylar film with printed polymer film 10 is unrolled onto a supporting layer 11. The supporting layer 11 is a seamed, full cross direction width layer, that is indexed and tensioned between rolls 12 and 13 of the apparatus. An uncured thermoplastic adhesive is applied to either the bottom of the web contacting layer or to the top of the supporting layer or both immediately prior to roll 14 of the apparatus, which provides sufficient force to adhere the printed polymer film to the support layer. The Mylar film is removed at roll 15 of the apparatus as the nascent multilayer composite fabric then travels through a heating device 17 which applies energy from an infrared or laser source to heat the nascent multilayer composite fabric such that the adhesive becomes thermoset. The adhesive becomes thermoset after heating preferably above approximately 150° Celsius and is also thermostable preferably up to approximately 250° Celsius. Preferred adhesives contain epoxy polymers. As previously disclosed, the web contacting layer has printed polymers that remain thermoplastic even after exposure to ultraviolet light. Additionally, the woven supporting layer has up to 50% thermoplastic polymers, or between 15% to 35%, or between 20% to 30% thermoplastic polymers. The thermoplastic polymers in both layers become plastic at temperatures above 200° C. The energy applied by the heating device 17 heats the nascent multilayer composite fabric above 200° such that these polymers become plastic and overlap/intermix and then return to the solid state after indexing through the device, and cooling. The entire surface area of the composite can be heated or less than the entire surface area can be heated through selective application of energy using the heating device 17. Heating the entire composite fabric could result in an excessive amount of bonding between the two layers such that fabric becomes too stiff and inflexible. The amount of bonding between the supporting layer 11 and polymer film (i.e., the web contacting layer) may be less than 60% or less than 40% or most preferably less than 30% relative to the total surface area of the interface between the supporting layer and the polymer film. The length of each bond is preferably about or less than 5 mm, less than 4 mm, less than 3 mm, or less than 2 mm in any direction. The bonds can occur between the web contacting layer and the MD and/or CD monofiliaments and/or multifilaments of the supporting layer.

The support layer and web contacting layer are indexed until the entire length of the support layer has been laminated with the web contacting layer to form the multilayer composite belt. Ultrasonic energy may be applied separately or in conjunction with infrared or laser energy to plasticize the thermoplastic polymers and aid in lamination. Using this method, the printed polymer can be discrete elements or a continuous film. If creating a papermaking fabric to be utilized as an imprinting or structuring fabric, the ability to create discrete elements or a continuous polymer layer, to be used as a web contacting layer, provides for a broad array of imprinting designs and properties of the finished product tissue web. Additionally, using discrete elements results in a composite multilayer fabric where the web contacting layer does not have a seam at all. If using a continuous film as the web contacting layer, then seaming the ends is performed as previously described. Solvent bonding may also be used for seaming as explained in subsequent exemplary embodiments.

The lamination bond is tested with use of a peel force test to determine sufficient bond strength between the papermaking layer and the woven fabric layer for the papermaking application. Below is a description of the peel force test.

Peel Force Test

An Instron Tensile Tester with two clamps was used to perform the peel force test. Narrow strips were cut from the belt in the machine direction (MD) or cross-machine direction (CD), each 4 in. long (100 mm). Initially, a small portion of the belt was peeled apart by hand, and then a strip from the papermaking top fabric and the woven bottom fabric was each placed in opposite clamps. The setting was set from 10 mm-90 mm of movement from the original length (10% to 90%) and a speed setting of 300 mm/min, and the Instron was started to peel the two strips from each other, while measuring the peel force result in N. The result was then converted to gf by multiplying by 1000 unit conversion. The peel force lamination bond strength was targeted to be greater than 1400 gf and less than 4000 gf.

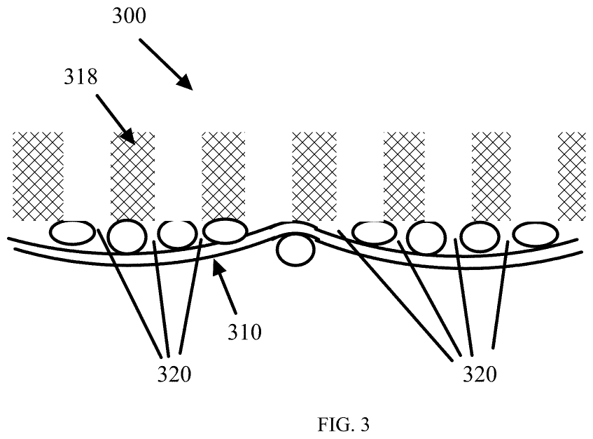

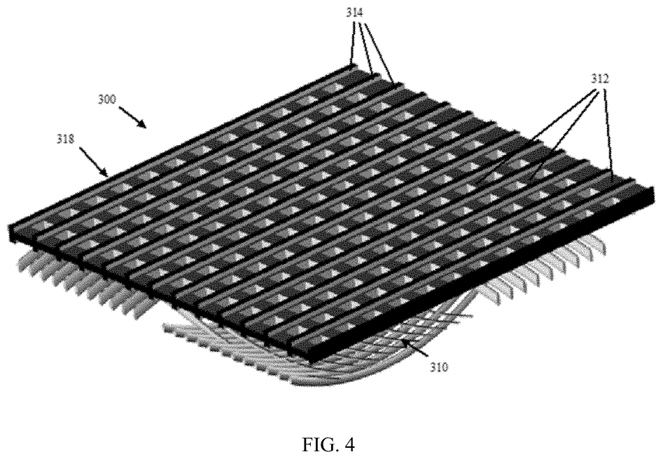

In exemplary embodiments, the 3-D printing processes described herein may be used to form belts that have air pockets in the X,Y, and Z directions. In this regard, FIG. 3 is a cross-sectional view and FIG. 4 is a perspective view of a belt or fabric, generally designated by reference number 300, according to an exemplary embodiment of the present invention. The belt or fabric 300 is produced by laminating an extruded polymeric netting strip, extruded polymer strip, or 3D printed polymer web contacting layer 318 to a supporting woven layer 310. The web contacting layer 318 includes CD aligned elements 314 and MD aligned elements 312. The CD aligned elements 314 and the MD aligned elements 312 cross one another with spaces between adjacent elements so as to form openings. Both the web contacting layer 318 and woven supporting layer 310 have non-planar, irregularly shaped surfaces that when laminated together only bond together where the two layers come into direct contact. The lamination results in the web contacting layer 318 extending only partially into the supporting layer 310 so that any bonding that takes place between the two layers occurs at or near the surface of the supporting layer 310. In a preferred embodiment, the web contacting layer 318 extends into the supporting layer 310 to a depth of 30 microns or less. As shown in FIG. 3, the partial and uneven bonding between the two layers results in formation of air channels 320 that extend in the X-Y plane of the fabric or belt 300. This in turn allows air to travel in the X-Y plane along a sheet (as well as within the fabric or belt 300) being held by the fabric or belt 300 during TAD, UCTAD, or ATMOS processes.

Without being bound by theory, it is believed that the fabric or belt 300 removes higher amounts of water due to the longer airflow path and dwell time as compared to conventional designs. In particular, previously known woven and overlaid fabric designs create channels where airflow is restricted in movement in regards to the X-Y direction and channeled in the Z-direction by the physical restrictions imposed by pockets formed by the monofilaments or polymers of the belt. The inventive design utilized in the present invention allows for airflow in the X-Y direction, such that air can move parallel through the belt and web across multiple pocket boundaries and increase contact time of the airflow within the web to remove additional water. This allows for the use of belts with lower permeability compared to conventional fabrics without increasing the energy demand per ton of paper dried. The air flow in the X-Y plane also reduces high velocity air flow in the Z-direction as the sheet and fabric pass across the molding box, thereby reducing the formation of pin holes in the sheet.

In an exemplary embodiment, the inventive process uses an extruded polymeric netting strip or an extruded polymer strip (that is then engraved, embossed, or laser drilled) as the web contacting layer, which is spirally wound and laminated to a supporting layer comprised of woven monofilaments or multi-filamentous yarns (with or without monofilaments) needled with fine synthetic batt fibers. The spirally wound process can be viewed in U.S. Pat. No. 8,980,062 and is preferably utilized when a web contacting layer of full paper machine width cannot be produced.

In an exemplary embodiment, the polymers used to produce the web contacting layer and/or the woven support layer include thermosetting and thermoplastic polymers including, but not limited to polyester, polyamide, polyurethane, polypropylene, polyethylene, polyethylene terephthalate, or polyether ether ketone resins. Preferably, up to 50%, or between 15% to 35%, or between 20% to 30% of the polymers used in the web contacting and supporting layer are thermoplastic. The thermoplastic polymers are utilized for improved seam bond strength of the web contacting layer and lamination strength of the web contacting layer to the woven support layer.

Prior to spirally winding and laminating the web contacting layer to the supporting layer, the edges of the web contacting layer may be cut using, for example, a laser. The laser may be used to produce overlapping structures and/or interlocking structures at the edges to improve seam strength and resiliance. Overlapping structures (FIGS. 6 and 7) provide large surface areas for increased bond area and thus seam strength after the seaming and lamination process. An overlapping structure in a seam is defined as an area where one edge of the fabric covers or extends over the second edge of the fabric. In addition or separate to an overlapping structure, an interlocking structure (FIGS. 10 and 11) can also be cut into the edges of the web contacting layer. An interlocking structure in a seam is defined as a projection from one edge of the fabric that connects into a recession of the second edge of the fabric. It is also preferred to have a seam that is angled such that any weak points in the paper web caused by the seam are not in alignment with the machine or cross machine direction where stresses in the web are at their peak. This helps reduce any breaks in the web that could potentially be caused by the seam. In order to angle the seam, the web contacting layer may be spirally wound and laminated to the second woven support layer. The angle of the seam is between 0 to 90 degrees, more preferably 0 to 50 degrees or most preferably limited to roughly less than 15° compared to the MD direction using this method.

As the web contacting layer is spirally wound onto the woven support layer, the two layers are laminated together. The lamination process may utilize adhesives by applying the adhesive either to the bottom of the web contacting layer or to the top of the supporting layer or both. The adhesive may be applied prior to the layers being brought into contact during the spirally winding process. After spirally winding, the adhesive is cured and becomes thermoset by heating the composite, multilayer fabric using energy from infrared, ultraviolet, ultrasonic, or a laser source. The adhesive should become thermoset after heating above approximately 150° C. and also be thermostable to approximately 250° C. Preferred adhesives contain epoxy polymers. During the heating process, the temperature is raised above the temperature upon which the thermoplastic polymers in the web contacting and/or support layer become plastic. The temperature at which the thermoplastic polymers become plastic should preferably be above 200° C. After cooling, the thermoplastic polymers between the two layers are overlapped and/or intermixed and in the solid state, thus bonding the layers together. The entire surface area of the composite can be heated or less than the entire surface area can be heated.

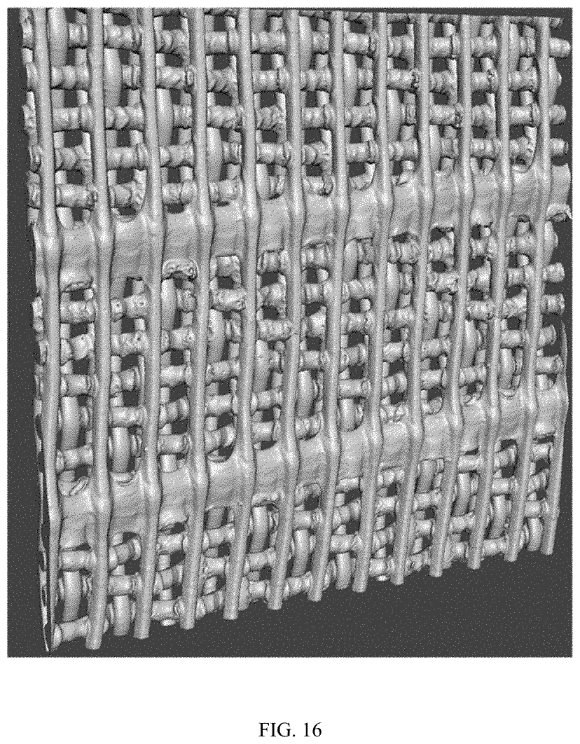

Heating the entire composite fabric could result in an excessive amount of bonding between the two layers such that the fabric becomes too stiff and inflexible. In this regard, during the bonding process, the thermoplastic polymers in the support layer flow outwardly and upwardly relative to the contact areas between the web contacting layer and the support layer. As shown in FIG. 15, this results in formation of components in the interface between the web contacting layer and the support layer that extend in the z-direction (i.e., up and around the individual elements of the web contacting layer), in addition to the x- and y-directions. Thus, the total surface area of the interface between the web contacting layer and the support layer includes the surface areas of the interfaces formed by the z-direction-extending components of the interface. In an exemplary embodiment, the amount of bonding between the web contacting layer and the support layer may range from 5 to 70 percent, based on the total surface area of the interface between the web contacting layer and the support layer.

The seam on the web contacting layer is also bonded during the spirally winding process and can utilize similar bonding techniques as mentioned above for laminating the web contacting layer with the supporting layer. The overlapping, interlocking, and/or lock and key structures are properly aligned during spirally winding prior to bonding the seam. Heating the entirety of the seam is preferred to provide for maximum bonding of the seam. To improve seam bonding, an activator can be applied to the overlapping, interlocking, and/or lock and key structures during the spirally winding process prior to heating such that additional energy is absorbed by the activator to ensure the seamed area is heated in its entirety to provide for maximum bonded area. This seam will thus become a unitary structure after bonding to provide for a seam that will not mark the sheet or cause sheet breaks.

Preferably, the seam has a variation in thickness (Z-direction) of less than 0.1 mm, or less than 0.08 mm, or less than 0.05 mm when measuring a laminated/composite fabric. Additionally, the air permeability of the seam may be less than 5%, or less than 3%, or less than 1% different than the body of the laminated fabric, as tested following the manual instructions of the Portable Air Permeability Tester FX 3360 PORTAIR available from TEXTEST AG, CH-8603 Schwerzenbach, Switzerland.

In accordance with another exemplary embodiment, solvent bonding may be used for lamination or seam bonding, either alone or in conjunction with the aforementioned bonding and lamination techniques. Solvent bonding applies a liquid chemical to the desired area to be seam bonded and/or to the areas of the two fabric layers to be laminated together in order to plasticize or swell the polymers in those areas. The chemical is either then evaporated or rinsed away with water to cause the polymers to return to their solid form. The polymers between the two layers are overlapped and/or intermixed by pressure by compressing between rolls and/or fused by heat energy, thus bonding the layers together. An exemplary embodiment utilizes a solvent comprised of approximately 1% to 5% polyethylene terephthalate, 1% to 5% thermoplastic polyurethane, solvated in 42% to 46% trifluoroacetic acid and 48% to 52% methylene chloride. This solvent is applied on either or both the two fabric areas to be laminated and then pressed together using a cylindrical roller using between 0 to 500 psi, more preferably 100 to 400 psi, and most preferably, 200 to 400 psi for zero to 15 minutes, more preferably 3-10 minutes. The laminated fabric is then heated to 50 deg C. to 100 deg C., or more preferably 60-80 deg C. using hot air for 10 to 20 minutes, more preferably 15 minutes, to evaporate the solvent.

The polymeric blend utilized for the web contacting layer, whether the layer be made from extruded polymeric netting strip, an extruded polymer strip (that is then engraved, embossed, or laser drilled) or a 3-D printed strip, is preferably photocured, PolyJet printed material. One surprising result of using a polymer blend with these properties is compressibility and resilience of the web contacting layer when traveling through a nip.

### Example

A laminated composite fabric was provided having a web contacting layer with the following geometries: extruded MD strands of 0.26 mm×CD strands of 0.40 mm, with a mesh of 30 MD strands per inch and a Count of 9 CD strand per inch, % contact area of 26% with solely MD strands in plane in static measurement and then with 48% contact area under load as the structure compressed and the CD ribs moved up in the papermaking top plane, due to use of a thermoplastic polyurethane (“TPU”) elastomeric material. The TPU material is a softer material and measured in the range of 65 to 75 Shore A Hardness while the woven bottom layer comprised of harder PET measured 95 to 105 Shore A Hardness using a portable Shore A Durometer test device calibrated per ASTM D 2240, the Mitutoyo Hardmatic HH-300 series, ASTD. The composite fabric was used on a TAD machine using a specific furnish recipe and paper machine running conditions, as follows:

Two webs of through air dried tissue were laminated to produce a roll of 2-ply sanitary (bath) tissue. Each tissue web was multilayered with the fiber and chemistry of each layer selected and prepared individually to maximize product quality attributes of softness and strength. The first exterior layer, which was the layer that contacted the Yankee dryer, was prepared using 80% eucalyptus with 0.25 kg/ton of the amphoteric starch Redibond 2038 (Corn Products, 10 Finderne Avenue, Bridgewater, N.J. 08807) (for lint control) and 0.25 kg/ton of the glyoxylated polyacrylamide Hercobond 1194 (Ashland, 500 Hercules Road, Wilmington Del., 19808) (for strength when wet and for lint control). The remaining 20% of the first exterior layer was northern bleached softwood kraft fibers. The interior layer was composed of 40% northern bleached softwood kraft fibers, 60% eucalyptus fibers, and 1.0 kg/ton of T526, a softener/debonder (EKA Chemicals Inc., 1775 West Oak Commons Court, Marietta, Ga., 30062). The second exterior layer was composed of 20% northern bleached softwood kraft fibers, 80% eucalyptus fibers and 3.0 kg/ton of Redibond 2038 (to limit refining and impart Z-direction strength). The softwood fibers were refined at 115 kwh/ton to impart the necessary tensile strength.

The fiber and chemicals mixtures were diluted to solids of 0.5% consistency and fed to separate fan pumps, which delivered the slurry to a triple layered headbox. The headbox pH was controlled to 7.0 by addition of a caustic to the thick stock that was fed to the fan pumps. The headbox deposited the slurry to a nip formed by a forming roll, an outer forming wire, and inner forming wire. The slurry was drained through the outer wire, of a KT194-P design by Asten Johnson (4399 Corporate Rd, Charleston, S.C. USA), to aid with drainage, fiber support, and web formation. When the fabrics separated, the web followed the inner forming wire and dried to approximately 25% solids using a series of vacuum boxes and a steam box.

The web was then transferred to the laminated composite fabric with the aid of a vacuum box to facilitate fiber penetration into the fabric to enhance bulk softness and web imprinting. The web was dried with the aid of two TAD hot air impingement drums to 75% moisture before being transferred to the Yankee dryer.

The web was held in intimate contact with the Yankee drum surface using an adhesive coating chemistry. The Yankee dryer was provided with steam at 3.0 bar while the installed hot air impingement hood over the Yankee dryer was blowing heated air at up to 450 degrees C. In accordance with an exemplary embodiment of the present invention, the web was creped from the yankee dryer at 10% crepe (speed differential between the Yankee dryer and reel drum) using a blade with a wear resistant chromia titania material with a set up angle of 20 degrees, a 0.50 mm creping shelf distance, and an 80 degree blade bevel. In alternative embodiments, the web may be creped from the Yankee at 10% crepe using a ceramic blade at a pocket angle of 90 degrees. The web was cut into two of equal width using a high pressure water stream at 10,000 psi and was reeled into two equally sized parent rolls and transported to the converting process.

In the converting process, the two webs were plied together using mechanical ply bonding, or light embossing of the DEKO configuration (only the top sheet is embossed with glue applied to the inside of the top sheet at the high points derived from the embossments using and adhesive supplied by a cliché roll) with the second exterior layer of each web facing each other. The embossment coverage on the top sheet was 4%. The product was wound into a 190 sheet count roll at 121 mm.

### Comparative Example

The same papermaking process as that of the Example was carried out, except the composite fabric was replaced with a Prolux 005 fabric, supplied by Albany (216 Airport Drive Rochester, N.H. 03867 USA) and having a 5 shed design with a warp pick sequence of 1,3,5,2,4, a 17.8 by 11.1 yarn/cm Mesh and Count, a 0.35 mm warp monofilament, a 0.50 mm weft monofilament, a 1.02 mm caliper, with a 640 cfm and a knuckle surface that was sanded to impart 27% contact area with the Yankee dryer.

When using the laminated composite imprinting fabric of the Example on a TAD machine, a reduction in Yankee dryer motor load of approximately 10% was observed compared to when using a standard Prolux 005 imprinting fabric (Comparative Example). Also, the laminated belt structure with the elastomeric top papermaking fabric as used in the Example did not show a visible nip impression when pressed under load to 250 psi, while the standard woven base fabric made from harder PET filaments did show a significant and visual weave pattern strikethrough on nip impression paper (under the same 250 psi load).

Studies were performed to compare a papermaking process utilizing the composite fabric of the present invention with a papermaking process utilizing a conventional commercial woven fabric. The exact same furnish recipe and same paper machine running conditions were utilized in the study. The only change was the fabric. From tests on pilot scale equipment, it was believed that the composite fabric of the present invention would have higher contact area with the Yankee dryer. The higher contact area would be expected to result in more of the paper web being compressed into the chemical layer on the Yankee dryer and therefore adhering more tightly to the dryer. The increased adhesion would be expected to result in more resistance to the creping blade removing the sheet of paper from the Yankee. Therefore, the expectation was that with the composite fabric of the present invention, there would be an increased load on the Yankee dryer.

Surprisingly, the papermaking process with the composite fabric of the present invention resulted in the load on the Yankee dryer (as measured in amps) being 30% lower as compared to the Yankee dryer load in amps when using a standard commercial woven fabric. The paper sheet made with the composite fabric of the present invention was as tight (measured by crepe), and exceptionally flat off the blade, showing little dust at the crepe blade. Without being bound by theory, this is believed to be due to the increased ability of the web contacting layer to compress in the nip between the pressure roll and the Yankee dryer and then spring back to its original geometry after leaving the nip. With the increased compression, a lower amount of force is used to push the paper web into the chemical layer on the Yankee dryer, resulting in a web that is adhered to the Yankee over greater area with less force, resulting in less penetration into the Yankee dryer chemical layer.

Lint in the finished tissue product was significantly lower on the product made using the laminated composite imprinting fabric of the present invention. With the paper web not being so tightly bound to the Yankee dryer, but rather being pressed just onto the surface over greater area, the web was easily removed at the crepe blade with any defects in the paper web caused by stock and water drips easily passing the blade without resulting in a sheet break. Without being bound by theory, it is possible that the surface of the paper web was not disrupted by the creping blade as the blade passed under the paper web into the Yankee chemical layer during creping. With the paper web not touching the crepe blade, fibers on the surface of the web were not debonded from the web surface to result in lint during use.

The papermaking machine process using the standard fabric resulted in much more fiber observed at the creping blade. It has been discussed in literature that a Yankee coating matrix is layered, sometimes with inner layers experiencing more time and heat, resulting in more tack. With the same press load and higher pressure on knuckles of a standard fabric, the sheet is pressed into and adheres strongly to this inner layer, which holds areas of the sheet more, and with the blade just penetrating to these areas, creates more point adhesion, dust and picking.

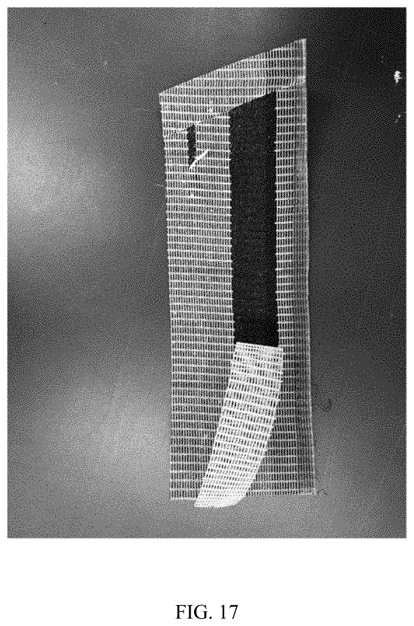

Structuring fabrics utilized in the present invention have a web contacting layer that can have damaged sections replaced to avoid having to change the entire fabric. This can be accomplished by using a 3-D printed web contacting layer comprised of thermoplastic and thermoset polymers. The 3-D printed web contacting layer is completely comprised of a mixture of thermoplastic and thermoset polymers of one color with only thermoset polymers of a different color utilized to produce a visually and chemically distinct continuous and repeating pattern in the web contacting layer. The distinct, repeating, continuous pattern comprised of only thermoset polymers is unable to be melted or fused, using energy or solvent, and thus is not laminated to the supporting layer using typical ultraviolet, laser, infrared, or solvent laminating techniques. Therefore, after spirally winding and laminating a web contacting layer of this composition to a supporting layer, there will be a visually continuous pattern of non-laminated material in the web contacting layer with the remainder of the web contacting layer being laminated and bonded to the supporting layer. In the event that a section of the web contacting layer is damaged uring use, the damaged area can be removed by cutting through the web contacting layer along a section of the repeating pattern composed of non-laminated material that surrounds the damaged area. The section of web contacting layer may be cut manually using a razor blade/knife and then that section can be pulled manually from the supporting layer to break the lamination bonding in order to remove the damaged section of web contacting layer. Because the web contacting layer is a continuous repeating pattern, patches of replacement web supporting fabric are available to replace damaged and removed sections of the web contacting fabric layer. These patches are preferably comprised of a high percentage of thermoplastic polymers that can be bonded to the woven supporting layer using a hand-held ultraviolet light, laser, adhesive, and/or solvent welding to create a secure bond between the patch and the woven fabric bottom layer. FIG. 16 shows a damaged section of laminated fabric that was repaired using a patch with a solvent comprised of approximately 1% polyethylene teraphlate, 1% thermoplastic polyurethane, with 46% trifluoroacetic acid and 52% methylene chloride. The repaired fabric is shown in FIG. 17.

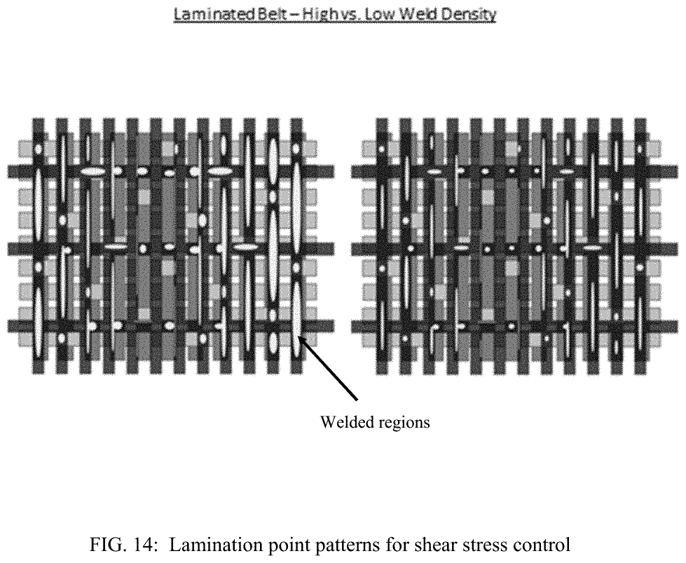

More detail about the thermal characteristics of the top imprinting layer is described by analysis of the material by thermal differential scanning calorimetry (“DSC”) scans. The network or co-polymer matrix will have a first relaxation temperature. FIG. 13 shows a DSC scan of thermoplastic polyurethane (TPU) (with some added block co-polymer of polyester) netting produced commercially with elevated thermal stability. The DSC scans are produced by first cooling the sample to 25° C. and heating it up to 250° C. at a 10° C./min rate. The final scan is produced by cooling the sample to −20° C. at −20° C./min rate and then heating from −20° C. to 250° C. at 10° C./min rate. Relaxation temperatures are recorded by the final scan. The first relaxation temperature is the point where the lamination bond between the two layers will start to alter and ultimately fail. Exemplary embodiments of the invention provide a zone where the thermal properties of the composite belt are fexible but thermally stable. First relaxation temperatures are best above belt temperatures in use. Current TAD machines will incur an imprinting belt temperature above 60° C., while air temperature flow to the belt can be >100° C. The belt remains wet due to transfer of the sheet to the Yankee surface at >5% moisture, or above 10% moisture or above 20% moisture contact. The hot air flow from the TAD section also first comes into contact with the wet sheet side (imprinted side on belt) where the wet paper helps to protect the imprinting belt from heat damage. It is desirable to keep the Shore A hardness of the imprinting layer below 80 and yet thermally stable with a first relaxation temperature above 70° C., or above 80° C., or above 90° C.

In exemplary embodiments, the present invention provides control of the point of bonding between the laminates. This can be done by controlling the point where the laser fuses the two layers. This can be done by altering the number of black filaments in the base cloth. This can be achieved by intermittently adding black or clear PET filamants in CD warp or MD weft patterns. It is desirable to allow the laminated matrix to twist in the Z/MD/CD direction without applying levels of shear stresses at the lamination points. This allows the belt to flex in use and expand or contract in different zones of the fabric run where temperature and sheer forces are very different. When one section of the belt is in the TAD zone, it can be exposed to air temperatures >150° C. and at the same time the belt is being cleaned for mill water and lubricated with TAD release which is below 50° C. Ridged bonding or continuous bonding greater than 10 mm in the MD or CD direction can create stresses so great the matrix will be forced to delaminate. Optimal bonding length between the laminate is a direct function to the circumferance of the smallest roll in a fabric run or better stated, the angle of wrap the belt experiences in the structuring fabric run on the machine. The higher the angle of wrap will require the shorter distance of the bonding between the two layers. The differential of CD tension can be controlled by the roll crown and hence control the distance of bonding in CD direction.

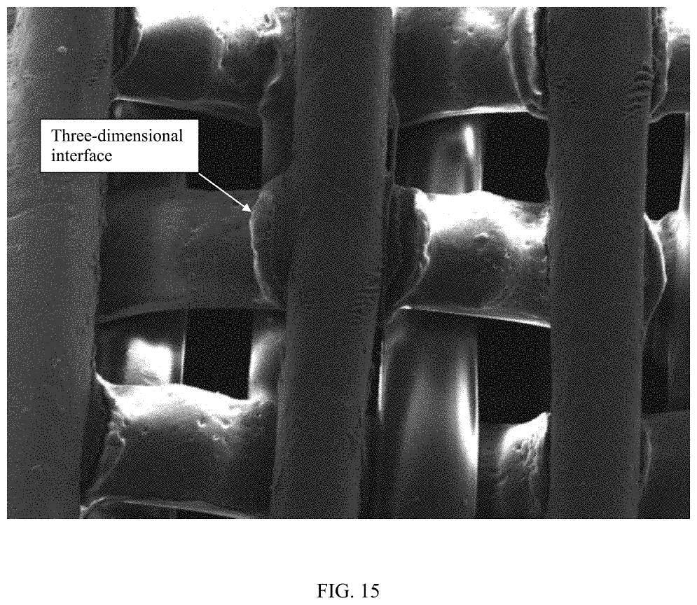

The bonding distance and bond pattern or shape can be controlled by the number and pattern of black or energy receiving filaments of the base woven cloth. Alternatively, or in addition, the bonding distance and bond pattern or shape may be controlled by applying patterned applications of laser energy activators, such as, for example, Clearweld™. Other methods involve controlling the pattern the laser moves across the lamination surface or accurately moving the laser to point patterns across the matrix, as shown in FIG. 14. Specifically, FIG. 14 shows disctrete welded regions formed between the support layer and the web contacting layer. Each welded region has a length and a width, and in exemplary embodiments the size of the smaller of the length and width is at least 0.16 mm and the size of the greater of the length and width is 2.35 mm or less. Still other methods to control bonding include patterned glue applications, solvent welding or any method to apply energy between the two plys to laminte the two plys in a pattern with a length less then 5 mm in any direction.

The density of lamination points or areas are preferably controlled. Areas of the fabric (edges) where forces are uneven are preferably adjusted to compensate for the expansion and contraction forces. In this regard, the desity of lamination points may be greater and the length reduced to compensate for the uneven stresses applied to the matrix in the structured fabric run.

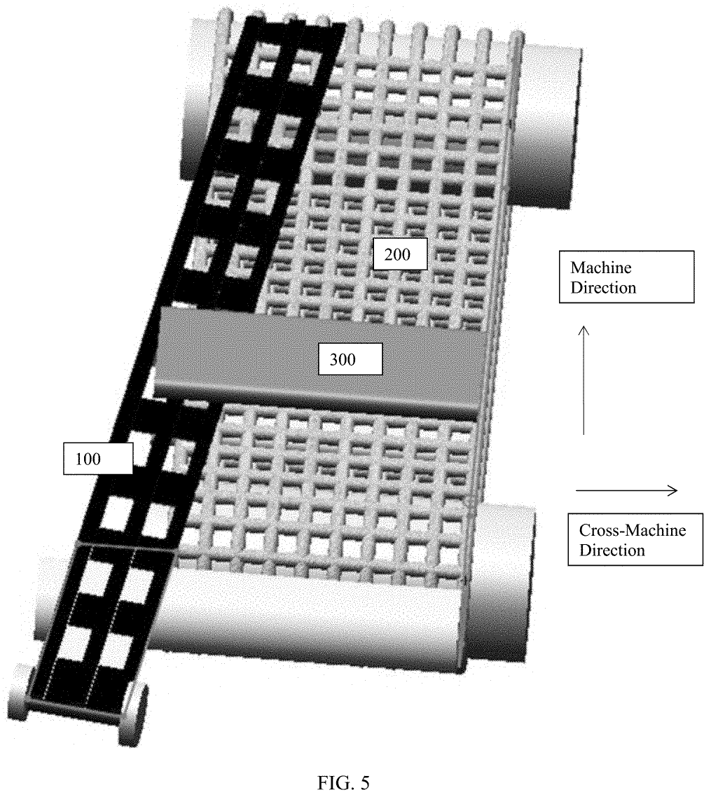

FIG. 5 shows the comparative process of spirally winding a web contacting layer and lamination of the web contacting layer to a woven supporting layer, where the web contacting layer has not been laser cut or printed to provide edges with overlapping, interlocking, and/or lock and key structures. As shown, a strip 100 of web contacting layer material is unwound and laid upon the woven supporting layer 200, and then the strip 100 is bonded with the woven supporting layer 200 by an apparatus 300 which uses, for example, adhesives, laser, infrared, solvent, utravilolet, or ultrasonic bonding for lamination. The strip 100 of web contacting layer is not as wide as the woven layer 200, which requires that the one continuous strip 100 be moved in the cross direction as the endless woven layer 200 is continually indexed in the machine direction until the entire woven layer 200 is covered and laminated to the web contacting layer. Without any overlapping, interlocking, and/or lock and key to the edges of the web contacting fabric seam, a primarily machine direction oriented seam is produced which can mark the paper sheet and cause sheet breaks that result in downtime and which has limited seam bond strength, which could result in premature failure or delamination.

Referring back to FIG. 6, a single strip of the web contacting layer will have two edges, and one edge may have an overlapping structure 500 that extends on top of or over a mating structure 600 of the second edge. When spirally wound and laminated to a woven supporting layer, the two edges of the web contacting fabric will overlap to form a high strength, non-marking seam.

Referring back to FIG. 7, one edge of the strip of web contacting layer may have an overlapping structure 650 that extends on top of or over a mating structure 660 of the second edge of the strip. When spirally wound and laminated to a woven supporting layer, the two edges of the web contacting fabric will overlap to form the improved seam.

Referring back to FIG. 8, one edge of the strip of web contacting layer may have a key structure 670 that fits into a lock structure 680 of the second edge. When spirally wound and laminated to a woven supporting layer, the key structures will be inserted into the lock structures of the web contacting fabric to form the improved seam.

Now that embodiments of the present invention have been shown and described in detail, various modifications and improvements thereon will become readily apparent to those skilled in the art. Accordingly, the spirit and scope of the present invention is to be construed broadly and not limited by the foregoing specification.

1. A method of forming a structured papermaking fabric, comprising:
printing a thermosetting polymer blend onto a non-stick film in a pattern;
curing the thermosetting polymer blend;
removing the cured thermosetting polymer blend from the non-stick film, the removed and cured thermosetting polymer blend forming a web-contacting layer of the structured papermaking fabric; and
laminating the web-contacting layer to a woven fabric to form the structured papermaking fabric.

2. The method according to claim 1, wherein the thermosetting polymer blend comprises from 10% to 85% by weight photopolymer and the step of curing comprises use of ultraviolet light.

3. The method according to claim 2, wherein the thermosetting polymer blend comprises a polymer selected from the group consisting of polyester, polyamide, polyurethane, polypropylene, polyethylene, polyethylene terephthalate, polyether ether ketone resins and combinations thereof.

4. The method according to claim 1, wherein the non-stick film is biaxially-oriented polyethylene terephthalate.

5. The method according to claim 1, wherein the step of laminating comprises at least one of adhesive or welding.

6. The method according to claim 5, wherein the welding is laser welding.

7. The method according to claim 6, wherein the step of laminating comprises forming distinct bonds that are spaced apart.

8. The method of claim 7, wherein the bonds have a length of 5 mm or less.

9. The method according to claim 7, wherein the removed and cured thermosetting polymer blend forms a strip comprising a first end and a second end, and the method further comprises spirally winding the strip onto the woven fabric.

10. The method of claim 9, wherein the step of spirally winding comprises forming a seam between the first and second ends.

11. The method of claim 10, wherein the seam extends at a 0° to 90° angle relative to a machine direction of the fabric.

12. The method of claim 9, further comprising the step of forming first structures at the first end and second structures at the second end, where the first structures at least one of overlap or interlock with the second structures to form the seam.

13. The method of claim 12, wherein the first and second structures form lock-and-key structures.

14. A two layer imprinting belt for a papermaking machine, the imprinting belt comprising bonds between layers of 5 mm or less in any direction.

15. A structured papermaking fabric comprising:
a web-contacting layer made of a thermosetting polymer blend; and
a woven fabric laminated to the web-contacting layer by distinct bonds that are spaced apart.

16. The structured papermaking fabric of claim 15, wherein the thermosetting polymer blend comprises from 10% to 85% by weight photopolymer.

17. The structured papermaking fabric of claim 15, wherein the thermosetting polymer blend comprises a polymer selected from the group consisting of polyester, polyamide, polyurethane, polypropylene, polyethylene, polyethylene terephthalate, polyether ether ketone resins and combinations thereof.

18. The structured papermaking fabric of claim 15, wherein the woven fabric is lamined to the web-contacting layer by at least one of adhesive or welding.

19. The structured papermaking fabric of claim 18, wherein the welding is laser welding.

20. The structured papermaking fabric of claim 15, wherein the bonds have a length of 5 mm or less.

21. The structured papermaking fabric of claim 15, wherein the web-contacting layer comprises a strip of material having a first end and a second end, and the strip of material is spirally wound onto the woven fabric.

22. The structured papermaking fabric of claim 21, wherein the web-contacting layer further comprises a seam formed between the first and second ends.

23. The structured papermaking fabric of claim 22, wherein the seam extends at a 0° to 90° angle relative to a machine direction of the fabric.

24. The structured papermaking fabric of claim 22, wherein the web-contacting layer further comprises first structures at the first end and second structures at the second end, where the first structures at least one of overlap or interlock with the second structures to form the seam.

25. The structured papermaking fabric of claim 24, wherein the first and second structures form lock-and-key structures.
